(19) United States
(12) Patent Application Publication
(10) Pub. No.: US 2026/0135681 A1
(43) Pub. Date: May 14, 2026

(54) SUB-BAND FULL-DUPLEX-AWARE USER EQUIPMENT CAPABILITY REPORTING AND CONFIGURATIONS

(71) Applicant: QUALCOMM Incorporated, San Diego, CA (US)

(72) Inventors: Abdelrahman Mohamed IBRAHIM, San Diego, CA (US); Muhammad Sayed Khairy ABDELGHAFFAR, San Jose, CA (US)

(21) Appl. No.: 19/299,550

(22) Filed: Aug. 14, 2025

Related U.S. Application Data
(60) Provisional application No. 63/718,344, filed on Nov. 8, 2024.

(51) Int. Cl. H04L 5/14; H04W 8/24

(52) U.S. Cl. CPC H04L 5/14; H04W 8/24

(57) ABSTRACT

Various aspects of the present disclosure generally relate to wireless communication. In some aspects, a user equipment (UE) may transmit, to a network node, capability information that indicates support for at least one of a first sub-band full-duplex (SBFD) configuration or a second SBFD configuration. The UE may receive, from the network node, a configuration across SBFD slots and non-SBFD slots in accordance with the capability information. Numerous other aspects are described.

### CROSS-REFERENCE TO RELATED APPLICATION

This Patent Application claims priority to U.S. Provisional Patent Application No. 63/718,344, filed on November 8, 2024, entitled “SUB-BAND FULL-DUPLEX-AWARE USER EQUIPMENT CAPABILITY REPORTING AND CONFIGURATIONS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with sub-band full-duplex-aware user equipment capability reporting and configurations.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a user equipment (UE) for wireless communication. The UE may include one or more memories and one or more processors coupled to the one or more memories. The one or more processors may be configured to cause the UE to transmit, to a network node, capability information that indicates support for at least one of a first sub-band full-duplex (SBFD) configuration or a second SBFD configuration. The one or more processors may be configured to cause the UE to receive, from the network node, a configuration across SBFD slots and non-SBFD slots in accordance with the capability information.

Some aspects described herein relate to a network node for wireless communication. The network node may include one or more memories and one or more processors coupled to the one or more memories. The one or more processors may be configured to cause the network node to receive, from a UE, capability information that indicates support for at least one of a first SBFD configuration or a second SBFD configuration. The one or more processors may be configured to cause the network node to transmit, to the UE, a configuration across SBFD slots and non-SBFD slots in accordance with the capability information.

Some aspects described herein relate to a method of wireless communication performed by a UE. The method may include transmitting, to a network node, capability information that indicates support for at least one of a first SBFD configuration or a second SBFD configuration. The method may include receiving, from the network node, a configuration across SBFD slots and non-SBFD slots in accordance with the capability information.

Some aspects described herein relate to a method of wireless communication performed by a network node. The method may include receiving, from a UE, capability information that indicates support for at least one of a first SBFD configuration or a second SBFD configuration. The method may include transmitting, to the UE, a configuration across SBFD slots and non-SBFD slots in accordance with the capability information.

Some aspects described herein relate to a non-transitory computer-readable medium that stores a set of instructions for wireless communication by a UE. The set of instructions, when executed by one or more processors of the UE, may cause the UE to transmit, to a network node, capability information that indicates support for at least one of a first SBFD configuration or a second SBFD configuration. The set of instructions, when executed by one or more processors of the UE, may cause the UE to receive, from the network node, a configuration across SBFD slots and non-SBFD slots in accordance with the capability information.

Some aspects described herein relate to a non-transitory computer-readable medium that stores a set of instructions for wireless communication by a network node. The set of instructions, when executed by one or more processors of the network node, may cause the network node to receive, from a UE, capability information that indicates support for at least one of a first SBFD configuration or a second SBFD configuration. The set of instructions, when executed by one or more processors of the network node, may cause the network node to transmit, to the UE, a configuration across SBFD slots and non-SBFD slots in accordance with the capability information.

Some aspects described herein relate to an apparatus for wireless communication. The apparatus may include means for transmitting, to a network node, capability information that indicates support for at least one of a first SBFD configuration or a second SBFD configuration. The apparatus may include means for receiving, from the network node, a configuration across SBFD slots and non-SBFD slots in accordance with the capability information.

Some aspects described herein relate to an apparatus for wireless communication. The apparatus may include means for receiving, from a UE, capability information that indicates support for at least one of a first SBFD configuration or a second SBFD configuration. The apparatus may include means for transmitting, to the UE, a configuration across SBFD slots and non-SBFD slots in accordance with the capability information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIGS. 3A-3C are diagrams illustrating examples of full-duplex (FD) communication, in accordance with the present disclosure.

FIG. 4 is a diagram illustrating examples of FD communication in a wireless network, in accordance with the present disclosure.

FIG. 5 is a diagram illustrating an example of configurations for sub-band full-duplex (SBFD) transmissions and receptions across SBFD and non-SBFD symbols, in accordance with the present disclosure.

FIG. 6 is a diagram illustrating an example configuration where transmissions and/or receptions across SBFD symbols and non-SBFD symbols are restricted to SBFD symbols only or non-SBFD symbols only, in accordance with the present disclosure.

FIG. 7 is a diagram illustrating an example configuration where downlink receptions across SBFD symbols and non-SBFD symbols can be in SBFD symbols and non-SBFD symbols, in accordance with the present disclosure.

FIG. 8 is a diagram illustrating an example configuration where uplink transmissions across SBFD symbols and non-SBFD symbols can be in SBFD symbols and non-SBFD symbols, in accordance with the present disclosure.

FIGS. 9A-9B are diagrams of examples associated with SBFD-aware user equipment (UE) capability reporting and configurations, in accordance with the present disclosure.

FIG. 10 is a diagram illustrating an example process performed, for example, at a UE or an apparatus of a UE, in accordance with the present disclosure.

FIG. 11 is a diagram illustrating an example process performed, for example, at a network node or an apparatus of a network node, in accordance with the present disclosure.

FIGS. 12-13 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some examples, a wireless network may support full-duplex communication, which generally includes simultaneous bi-directional communication between devices in the wireless network. For example, a network node operating in a full-duplex mode may receive an uplink communication and transmit a downlink communication at the same time (for example, in the same slot or the same symbol). For example, a network node and/or a user equipment (UE) may support a sub-band full-duplex (SBFD) communication mode. In the SBFD mode, a network node may receive an uplink communication from a first UE in an uplink sub-band and may simultaneously transmit a downlink communication to a second UE in a downlink sub-band (for example, where simultaneous reception and transmission occurs in different frequency resources). For example, the uplink sub-band and the downlink sub-band may be different sub-bands within a frequency band or a component carrier, such as a time division duplexing (TDD) band. In this case, frequency resources used for downlink communication may be separated from frequency resources used for uplink communication, in the frequency domain, by one or more guard bands. In this way, the SBFD mode may result in increased throughput by allowing simultaneous uplink and downlink communication, reduced latency by allowing uplink and/or downlink communication to occur earlier in time, and/or increased spectral efficiency by simultaneously utilizing downlink and uplink resources.

As described herein, an SBFD-aware UE may be configured for communication across SBFD slots and/or symbols (e.g., slots and/or symbols in which a network node communicates in an SBFD mode) and/or non-SBFD slots and/or symbols (e.g., slots and/or symbols in which the network node communicates in a half-duplex mode). The SBFD-aware UE may be configured for communication across SBFD slots and/or symbols according to one of two configurations, which may be known as and/or referred to herein as Configuration 1 and Configuration 2. In Configuration 1, transmissions and receptions are restricted to SBFD symbols only or non-SBFD symbols only. In Configuration 2, transmissions and receptions may be in SBFD symbols and non-SBFD symbols. In some examples, a wireless network may differentiate the configuration for SBFD versus non-SBFD where frequency resources may differ between an SBFD slot and a non-SBFD slot, causing for example, an SBFD uplink transmission to potentially collide with a non-SBFD downlink reception.

However, enabling different configurations for managing SBFD communications poses challenges regarding whether a UE may be assigned a default configuration (e.g., Configuration 1 and/or Configuration 2), which configuration to designate a default configuration, how the UE may report capabilities to support one or more configurations, and/or whether one configuration may be a superset or a subset of another configuration. Furthermore, the utilization of one or more configurations may be limited to certain channels and/or signals, and the UE and network node performance and scheduling efficiency may benefit from information concerning these limitations. For example, a network node may avoid scheduling certain signals and/or channels depending on the limitations associated with one or more configurations.

Various aspects relate generally to a UE providing capability information to a network node indicating support for a first SBFD configuration and/or a second SBFD configuration, and the UE receiving, from the network node, a configuration across SBFD and non-SBFD slots according to the capability information. Some aspects more specifically relate to configuration options in which the second SBFD configuration is a superset of the first SBFD configuration and in which the first SBFD configuration is a default configuration. Alternatively, configuration options may include the first SBFD being a superset of the second SBFD configuration, where the second SBFD configuration may be a default configuration. In some aspects, the configuration across SBFD and non-SBFD slots applied to certain channels and/or signals may be based on the first SBFD configuration or the second SBFD configuration being active. In some aspects, the UE capability information may indicate whether fallback from the first configuration to the second configuration and/or from the second configuration to the first configuration is supported in certain conditions and/or according to certain channels and/or signals in use. In some aspects, one or more rules may be defined to address scenarios where a duplex mode or symbol type (e.g., SBFD or non-SBFD) is not indicated to the UE. Additionally, in a scenario where a duplex mode or symbol type is not indicated, the UE may assume that a configuration applies to one or more signals and/or channels and that a valid symbol type may be configured, indicated, and/or determined for the respective one or more signals and/or channels.

Particular aspects of the subject matter described in this disclosure can be implemented to realize one or more of the following potential advantages. In some examples, the described techniques can be used to enable the UE to adapt an SBFD-aware configuration across SBFD and non-SBFD symbols (e.g., the first configuration and/or the second configuration) to current network conditions and channel and/or signal conditions. For example, the first configuration may provide more flexibility when scheduling in SBFD and non-SBFD symbols, but the first configuration may increase radio resource control (RRC) overhead due to different channel configurations for SBFD and non-SBFD communications. Additionally, the first configuration may provide simpler separation between transmissions and/or receptions, resulting in limited interference and reduced complexity at the UE and the network node. Furthermore, the second configuration may require less RRC overhead relative to the first configuration, but the second configuration may provide less flexibility when scheduling in SBFD and non-SBFD symbols. Additionally, the second configuration may provide higher throughput, reduced latency, and/or improved spectral efficiency relative to the first configuration due to the use of SBFD and non-SBFD symbols, but the second configuration may cause greater interference (e.g., due to potentially less separation between transmissions and/or receptions), increased latency, and/or reduced spectral efficiency. By enabling the UE to report SBFD-aware configuration capabilities, to limit use of the first configuration and the second configuration for communication across SBFD and non-SBFD symbols to certain signals and channels, and to define the relationship between the first configuration and the second configuration (e.g., whether one is a superset of the other and/or which one is a default configuration), the UE and the network node may adapt transmission and reception activity to current network conditions and balance potential tradeoffs among increasing throughput, reducing latency, and/or increasing spectral efficiency.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, SBFD), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

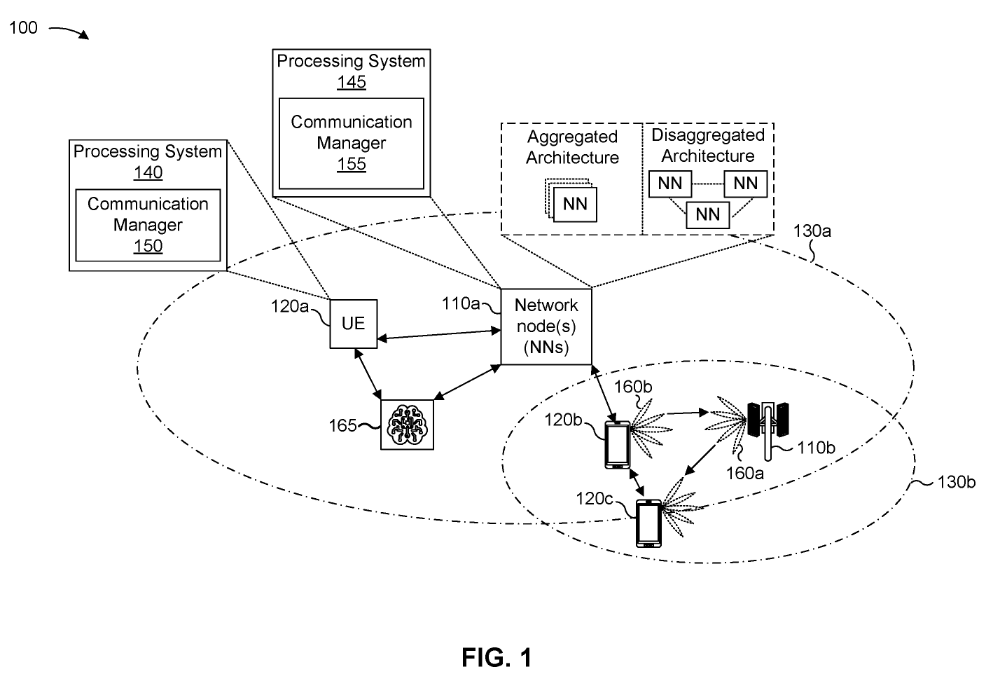

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally, or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

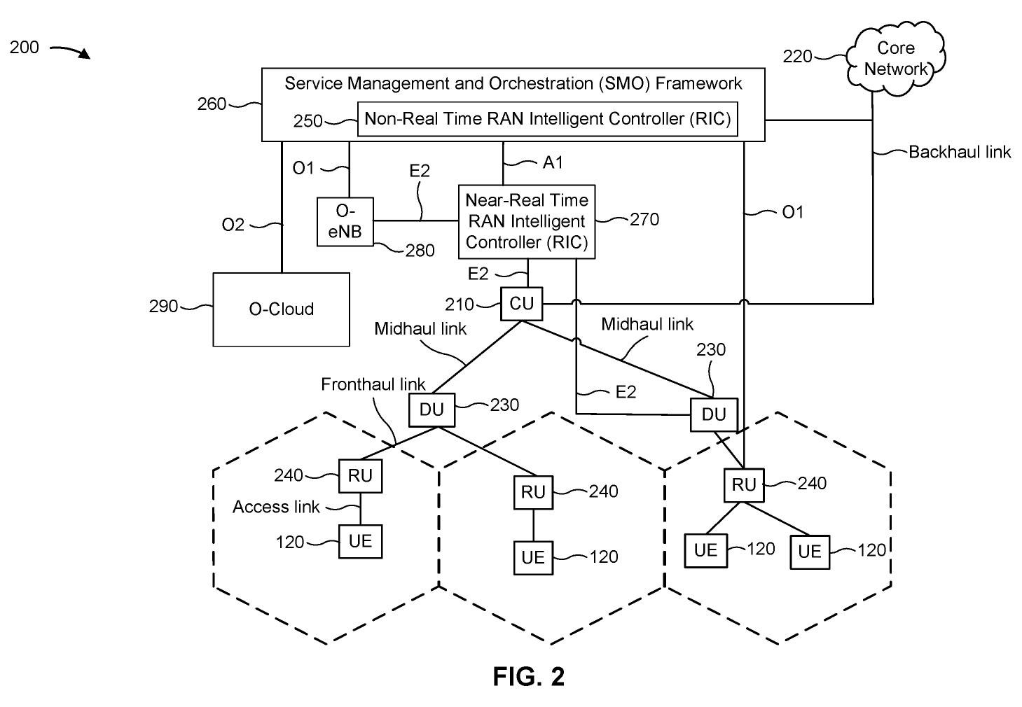

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of narrowband (NB)-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

A network node 110 or a UE 120 operating in a half-duplex mode may perform only one of transmission or reception during particular time resources, such as during particular slots, symbols, or other time periods. In various examples, some of the network nodes 110 and the UEs 120 of the wireless communication network 100 may be configured for full-duplex operation in addition to half-duplex operation. In full-duplex operation, a network node 110 or a UE 120 operating in a full-duplex (for example, SBFD) mode can transmit and receive communications concurrently (for example, in the same time resources). For example, as shown in FIG. 1, the network node 110b may operate in the full-duplex mode. The network node 110b may concurrently receive uplink communications from the UE 120b and transmit downlink communications to the UE 120c. By operating in a full-duplex mode, network nodes 110 and/or UEs 120 may generally increase the capacity of the network and the radio access link. In some examples, full-duplex operation may involve frequency division duplexing (FDD), in which downlink transmissions of the network node 110b are performed in a first frequency band or on a first component carrier and transmissions of the UE 120b are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an uplink transmission to a first network node 110 and receive a downlink transmission from a second network node 110 in the same time resources. In some other examples, full-duplex operation may be enabled for a network node 110 but not for a UE 120. For example, the network node 110b may simultaneously transmit a downlink transmission to a first UE 120 (for example, the UE 120c) and receive an uplink transmission from a second UE 120 (for example, the UE 120b) in the same time resources. In some other examples, full-duplex operation may be enabled for both a network node 110 and a UE 120.

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the UE 120 may include a communication manager 150. As described in more detail elsewhere herein, the communication manager 150 may transmit, to a network node, capability information that indicates support for at least one of a first SBFD configuration or a second SBFD configuration; and receive, from the network node, a configuration across SBFD slots and non-SBFD slots in accordance with the capability information. Additionally, or alternatively, the communication manager 150 may perform one or more other operations described herein.

In some aspects, the network node 110 may include a communication manager 155. As described in more detail elsewhere herein, the communication manager 155 may receive, from a UE, capability information that indicates support for at least one of a first SBFD configuration or a second SBFD configuration; and transmit, to the UE, a configuration across SBFD slots and non-SBFD slots in accordance with the capability information. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

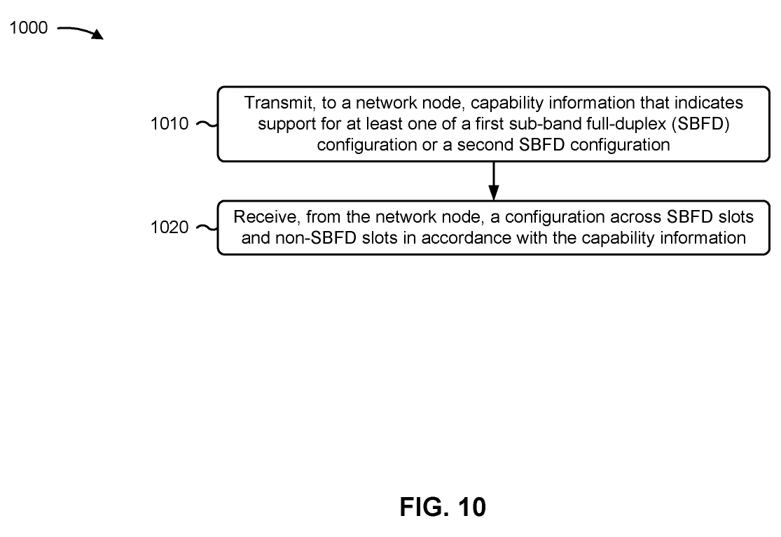

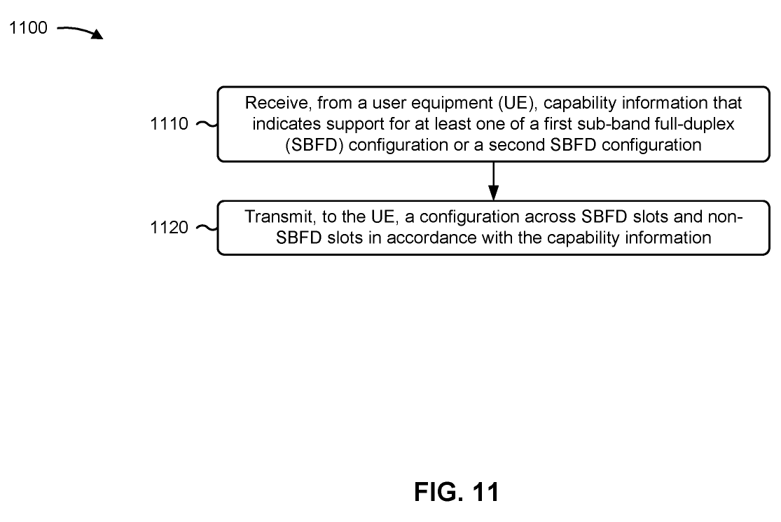

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with SBFD-aware UE capability reporting and configurations, as described in more detail elsewhere herein. For example, the processing system 145 of the network node 110, the processing system 140 of the UE 120, the CU 210, the DU 230, or the RU 240 may perform or direct operations of, for example, process 1000 of FIG. 10, process 1100 of FIG. 11, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1000 of FIG. 10, process 1100 of FIG. 11, or other processes as described herein. In some examples, executing instructions may include running the instructions, converting the instructions, compiling the instructions, and/or interpreting the instructions, among other examples.

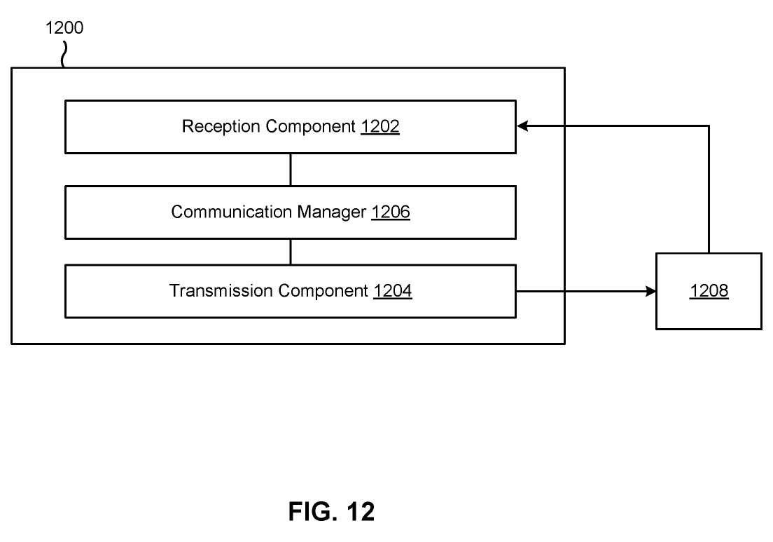

In some aspects, the UE 120 includes means for transmitting, to a network node 110, capability information that indicates support for at least one of a first SBFD configuration or a second SBFD configuration; and/or means for receiving, from the network node 110, a configuration across SBFD slots and non-SBFD slots in accordance with the capability information. The means for the UE 120 to perform operations described herein may include, for example, one or more of communication manager 150, processing system 140, a radio, one or more RF chains, one or more transceivers, one or more antennas, one or more modems, a reception component (for example, reception component 1202 depicted and described in connection with FIG. 12), and/or a transmission component (for example, transmission component 1204 depicted and described in connection with FIG. 12), among other examples.

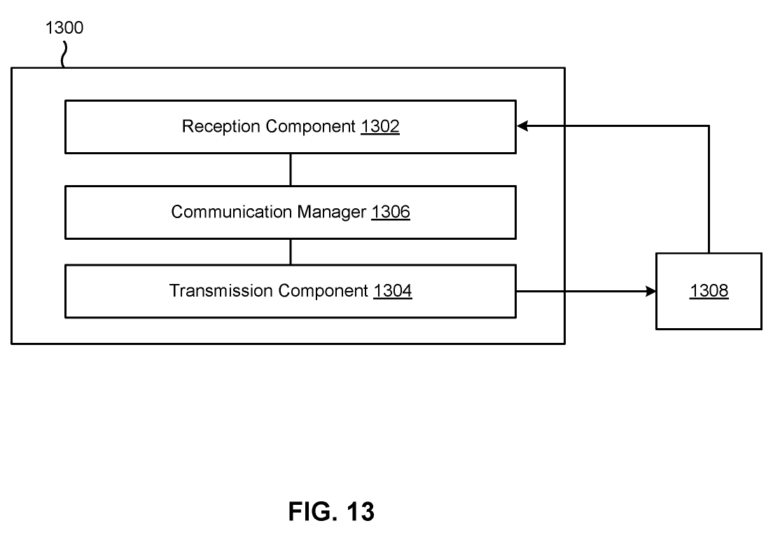

In some aspects, the network node 110 includes means for receiving, from a UE 120, capability information that indicates support for at least one of a first SBFD configuration or a second SBFD configuration; and/or means for transmitting, to the UE 120, a configuration across SBFD slots and non-SBFD slots in accordance with the capability information. The means for the network node 110 to perform operations described herein may include, for example, one or more of communication manager 155, processing system 145, a radio, one or more RF chains, one or more transceivers, one or more antennas, one or more modems, a reception component (for example, reception component 1302 depicted and described in connection with FIG. 13), and/or a transmission component (for example, transmission component 1304 depicted and described in connection with FIG. 13), among other examples.

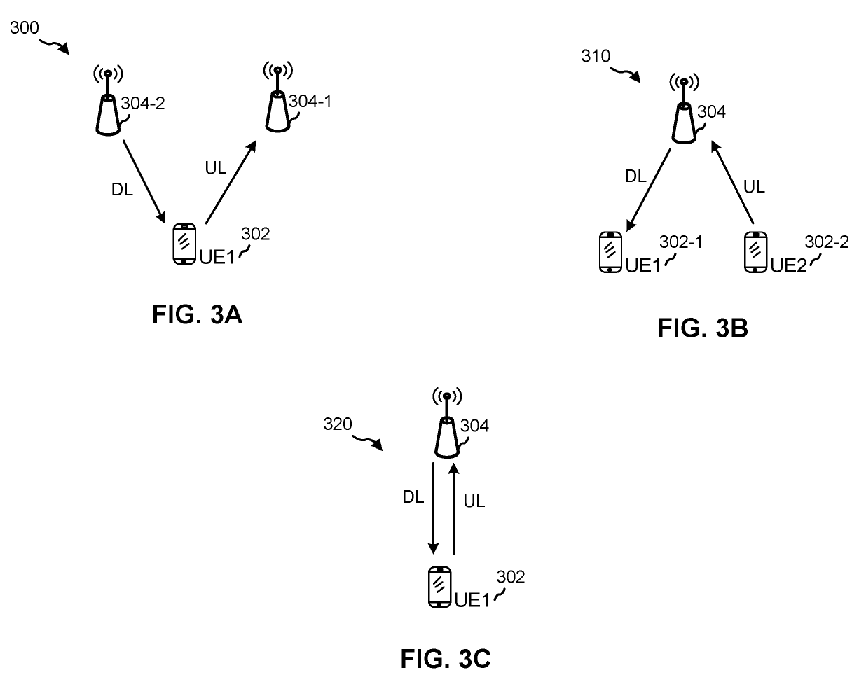

FIGS. 3A-3C are diagrams illustrating examples 300, 310, 320 of full-duplex (FD) communication, in accordance with the present disclosure. The example 300 of FIG. 3A includes a UE1 302 and two network nodes (e.g., TRPs) 304-1, 304-2, where the UE1 302 is sending UL transmissions to network node 304-1 and is receiving DL transmissions from network node 304-2. In the example 300 of FIG. 3A, FD is enabled for the UE1 302, but not for the network nodes 304-1, 304-2. The example 310 of FIG. 3B includes two UEs, shown as UE1 302-1 and UE2 302-2, and a network node 304, where the UE1 302-1 is receiving a DL transmission from the network node 304 and the UE2 302-2 is transmitting an UL transmission to the network node 304. In the example 310 of FIG. 3B, FD is enabled for the network node 304, but not for UE1 302-1 and UE2 302-2. The example 320 of FIG. 3C includes a UE1 302 and a network node 304, where the UE1 302 is receiving a DL transmission from the network node 304 and the UE1 302 is transmitting an UL transmission to the network node 304. In the example 320 of FIG. 3C, FD is enabled for both the UE1 302 and the network node 304. In some examples, SBFD communications may be enabled between a UE 302 and a network node 304, which is a full-duplex mode that supports simultaneous DL and UL communication in different sub-bands within the same frequency channel. In some examples, SBFD communications may be enabled at the network node 304 only, at the UE 302 only, or at the network node 304 and the UE 302.

As indicated above, FIGS. 3A-3C are provided as one or more examples. Other examples may differ from what is described with regard to FIGS. 3A-3C.

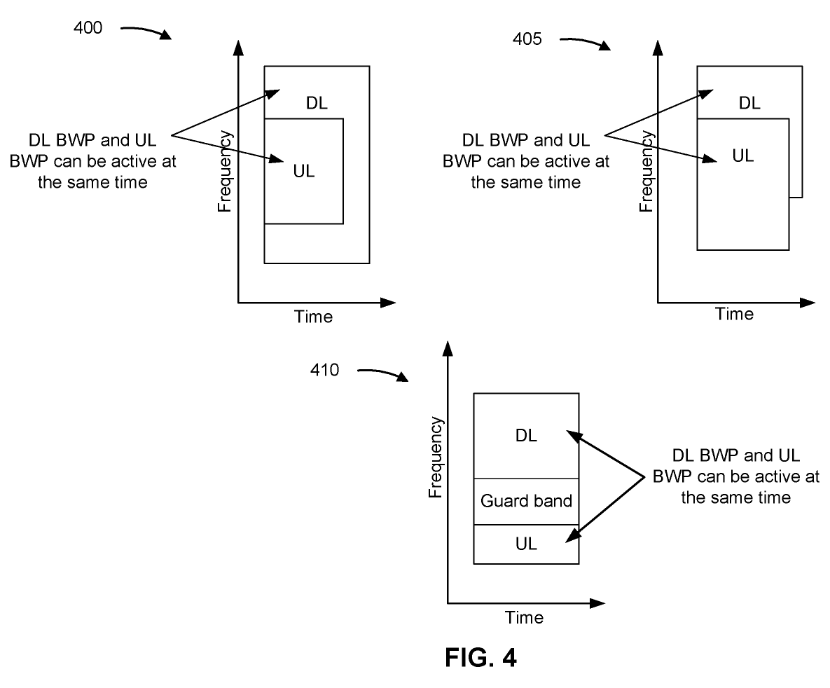

FIG. 4 is a diagram illustrating examples 400, 405, and 410 of FD communication in a wireless network, in accordance with the present disclosure. “Full-duplex communication” in a wireless network refers to simultaneous bi-directional communication between devices in the wireless network. For example, a UE operating in a FD mode may transmit an uplink communication and receive a downlink communication at the same time (e.g., in the same slot or the same symbol). “Half-duplex communication” in a wireless network refers to unidirectional communications (e.g., only downlink communication or only uplink communication) between devices at a given time (e.g., in a given slot or a given symbol).

As shown in FIG. 4, examples 400 and 405 show examples of in-band full-duplex (IBFD) communication. In IBFD, a UE may transmit an uplink communication to a base station and receive a downlink communication from the base station on the same time and frequency resources. As shown in example 400, in a first example of IBFD, the time and frequency resources for uplink communication may fully overlap with the time and frequency resources for downlink communication. As shown in example 405, in a second example of IBFD, the time and frequency resources for uplink communication may partially overlap with the time and frequency resources for downlink communication.

As further shown in FIG. 4, example 410 shows an example of SBFD communication, which may also be referred to as “sub-band frequency division duplex (SBFDD)” or “flexible duplex.” In SBFD, a UE may transmit an uplink communication to a base station and receive a downlink communication from the base station at the same time, but on different frequency resources. For example, the different frequency resources may be sub-bands of a frequency band, such as a time division duplexing band. In this case, the frequency resources used for downlink communication may be separated from the frequency resources used for uplink communication, in the frequency domain, by a guard band. In a network utilizing SBFD, spectral efficiency may be improved due to an increased quantity of transmissions occurring in the available spectrum.

As indicated above, FIG. 4 is provided as an example. Other examples may differ from what is described with respect to FIG. 4.

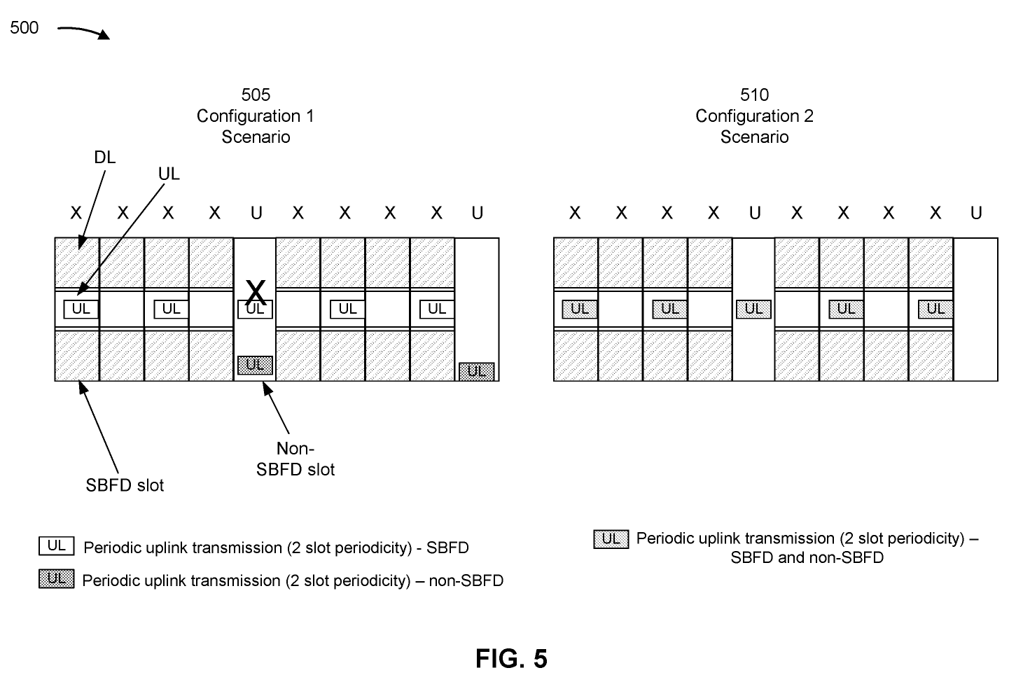

FIG. 5 is a diagram illustrating an example 500 of configurations for SBFD transmissions and receptions across SBFD and non-SBFD symbols, in accordance with the present disclosure.

For UL transmissions and DL receptions across SBFD symbols and non-SBFD symbols in different slots of an SBFD-aware UE (e.g., a UE that is aware of a network node having SBFD capabilities), each transmission or reception within a slot includes either all SBFD or all non-SBFD symbols. An SBFD-aware UE may be configured for communication across SBFD slots and/or symbols according to one of two configurations, which may be known as and/or referred to herein as Configuration 1 and Configuration 2. These configurations may determine whether transmissions and receptions are restricted to SBFD symbols or non-SBFD symbols in different slots.

As shown in reference number 505, in Configuration 1, transmissions and receptions are restricted to SBFD symbols only or non-SBFD symbols only. In some examples, a wireless network may differentiate the configuration for SBFD versus non-SBFD where frequency resources may not be the same between an SBFD slot and a non-SBFD slot, causing for example, an SBFD uplink transmission to potentially collide with a non-SBFD downlink reception. In some examples, a UE may not expect an SBFD transmission in a non-SBFD slot or a non-SBFD transmission in an SBFD slot. For example, where a non-SBFD slot includes an SBFD transmission, the SBFD transmission may be dropped according to Configuration 1. However, where the non-SBFD slot includes a non-SBFD transmission, the non-SBFD transmission may not be dropped according to Configuration 1.

As shown by reference number 510, in Configuration 2, transmissions and receptions may be in SBFD symbols and in non-SBFD symbols. In some examples, a UE may expect an SBFD transmission in a non-SBFD slot and a non-SBFD transmission in an SBFD slot.

In some examples, the SBFD-aware UE may be provided with Configuration 1 or Configuration 2 via an RRC configuration. Additionally, the RRC configuration may provide the SBFD-aware UE with Configuration 1 or Configuration 2 according to one or more granularity options. For example, in a first option, the SBFD-aware UE may be configured with Configuration 1 or Configuration 2 on a per-UE and per-serving cell basis. In a second option, the SBFD-aware UE may be configured with Configuration 1 or Configuration 2 on a per-UE, per-BWP, per-channel, and/or per-signal basis, where separate configurations for configured and dynamic transmissions and/or receptions for a given channel and/or signal may not be precluded. Additionally, in a third option, the SBFD-aware UE is configured with Configuration 1 or Configuration 2 on a per cell basis, where there may be no separate UE capabilities for Configuration 1 and Configuration 2. These different options enable the UE to choose from among these options to adapt to current network conditions. For example, the first option may provide the most flexibility in choosing a configuration depending on the serving cell, the third option provides the least flexibility where the configuration is chosen for a cell with no separate UE capabilities for Configuration 1 and Configuration 2, and the second option provides a level of flexibility between that of the first option and the third option.

As indicated above, FIG. 5 is provided as an example. Other examples may differ from what is described with respect to FIG. 5.

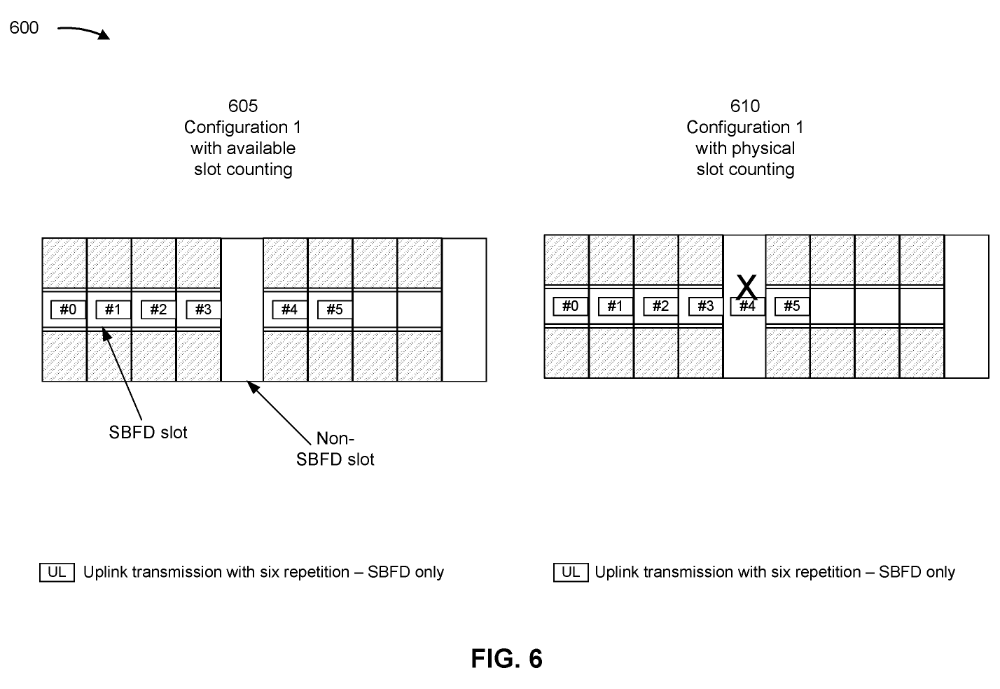

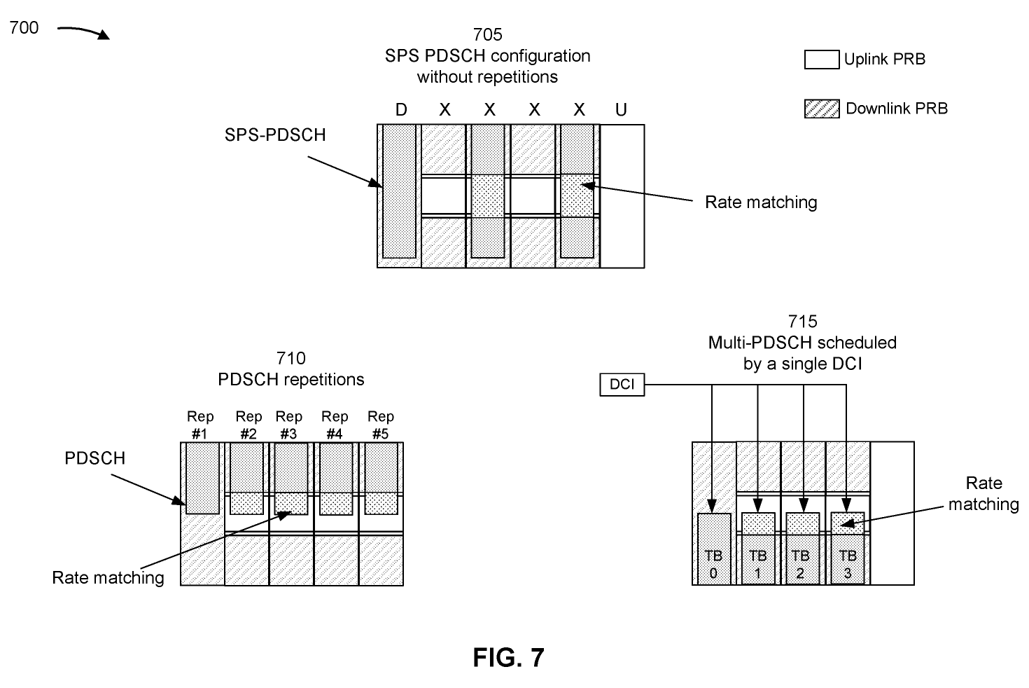

FIG. 6 is a diagram illustrating an example 600 configuration where transmissions and/or receptions across SBFD symbols and non-SBFD symbols are restricted to SBFD symbols only or non-SBFD symbols only, in accordance with the present disclosure. For example, in an SBFD-aware UE configured according to Configuration 1, transmissions and receptions are restricted to SBFD symbols only or non-SBFD symbols only, where the valid symbol type may be determined based on the type of signal or channel.

For example, in semi-statically configured transmissions and receptions without activation DCI (e.g., including periodic (P) SRS (P-SRS), P-CSI report, P-CSI reference signal (P-CSI-RS), and configured grant (CG)-Type 1 and excluding PDCCH), the valid symbol type may be configured by RRC signaling. For example, where the UE does not receive DCI to determine a valid symbol, the RRC signaling is able to provide an indication of the valid symbol. Additionally, for dynamically scheduled transmissions and receptions (e.g., PUSCH repetition, PDSCH repetition, multiple PUSCH, and multiple PDSCH), the valid symbol type may be determined based on the symbol type of the first transmission or reception.

As an additional example, for semi-persistent (SP)-CSI on PUCCH or PUSCH, type 2 CG PUSCH, semi-persistent scheduling (SPS) PDSCH, and semi-persistent SRS, the valid symbol may be determined according to one of two options, designated as Option 1 and Option 2.

In some examples, under Option 1, the valid symbol type may be explicitly configured. For example, the valid symbol type for SP-CSI on PUCCH or PUSCH may be explicitly configured in CSI-ReportConfig, the valid symbol type for type 2 CG PUSCH may be explicitly configured in ConfiguredGrantConfig, the valid symbol type for SPS PDSCH may be explicitly configured in SPS-Config and the valid symbol type for semi-persistent SRS may be explicitly configured in [SRS-Config / SRS-Resource Set / SRS-Resource].

In some examples, under Option 2, the valid symbol type may be determined based on a first symbol type after activation. For example, the valid symbol type for SP-CSI on PUCCH or PUSCH may be determined based on the symbol type of the first PUSCH/PUCCH after activation, the valid symbol type for type 2 CG PUSCH may be determined based on the symbol type of the first CG PUSCH associated with activation DCI, the valid symbol type for SPS PDSCH may be determined based on the symbol type of the first SPS PDSCH associated with activation DCI, and the valid symbol type for semi-persistent SRS may be determined based on the symbol type of the first SRS after activation.

Additionally, certain signals and channels may be configured to perform different methods of slot counting (e.g., available slot counting or physical slot counting) when Configuration 1 is enabled.

As shown by reference number 605, for a PUSCH repetition type A with available slot counting, TB processing over multiple slots (TBoMS), and/or PUCCH repetitions, the UE may postpone transmissions in an invalid symbol type. For example, the UE may postpone an SBFD UL transmission #4 in a non-SBFD slot to the next available SBFD slot, thereby skipping the uplink transmission in an otherwise available non-SBFD slot.

In contrast, and as shown by reference number 610, for a CG PUSCH and SPS PDSCH, P/SP SRS, P/SP CSI-RS, P/SP PUCCH, SP-CSI on PUSCH, PUSCH repetition type A without available slot counting, multi-PUSCH/PDSCH scheduled by a single DCI, and/or PDSCH repetitions, transmissions and receptions in an invalid symbol type are dropped. For example, in a physical slot counting configuration of Configuration 1, a transmission #4 (e.g., having an SBFD symbol type) scheduled in an invalid slot (e.g., a non-SBFD slot) may be dropped. Similarly, in a physical slot counting configuration of Configuration 1, a transmission having a non-SBFD symbol type scheduled in an invalid slot (e.g., an SBFD slot) may be dropped.

These options provide potential granularity within Configuration 1, but a UE may be unable to efficiently determine default configurations (e.g., Configuration 1 or Configuration 2) and to report UE capabilities as well as relevant signals and/or channels that are applicable to an enabled configuration. By reporting capabilities and relevant signals and/or channels to a network node, the SBFD configuration of a UE may be adapted to current network conditions and channel and/or signal conditions, thereby improving throughput, latency, and/or spectral efficiency.

As indicated above, FIG. 6 is provided as an example. Other examples may differ from what is described with respect to FIG. 6.

FIG. 7 is a diagram illustrating an example 700 configuration where downlink receptions across SBFD symbols and non-SBFD symbols can be in SBFD symbols and non-SBFD symbols, in accordance with the present disclosure. In some examples, where Configuration 2 is enabled for DL PDSCH, the assigned physical resource blocks (PRBs) within DL usable PRBs in SBFD symbols may be considered valid according to different PDSCH configurations. In some examples, where a downlink transmission overlaps with an uplink resource, the UE may assume that the overlapping portion of the downlink transmission is rate matched (e.g., punctured).

As shown by reference number 705, in an SPS PDSCH configuration without repetitions, if the reception occasions are across SBFD symbols and non-SBFD symbols where each reception occasion has either all SBFD or all non-SBFD symbols, only the assigned PRBs within DL usable PRBs in SBFD symbols may be considered valid, and the number of PRBs for transport block size (TBS) determination may be based on assigned PRBs or assigned PRBs within DL usable PRBs only. For example, where a downlink transmission overlaps with an uplink resource, the UE may assume that the overlapping portion of the downlink transmission is rate matched.

As shown by reference number 710, in a PDSCH repetition configuration across SBFD symbols and non-SBFD symbols in different slots where each repetition has either all SBFD or all non-SBFD symbols, only the assigned PRBs within DL usable PRBs in SBFD symbols may be considered valid, and the number of PRBs for TBS determination may be based on assigned PRBs (e.g., based on assigned PRBs within DL usable PRBs only, or based on assigned PRBs within DL usable PRBs of the first repetition).

As further shown by reference number 715, in a multi-PDSCH configuration scheduled by a single DCI across SBFD symbols and non-SBFD symbols, where each PDSCH within a slot has either all SBFD or all non-SBFD symbols, only the assigned PRBs within DL usable PRBs in SBFD symbols may be considered valid, and the number of PRBs for TBS determination may be based on assigned PRBs or assigned PRBs within DL usable PRBs only.

As indicated above, FIG. 7 is provided as an example. Other examples may differ from what is described with respect to FIG. 7.

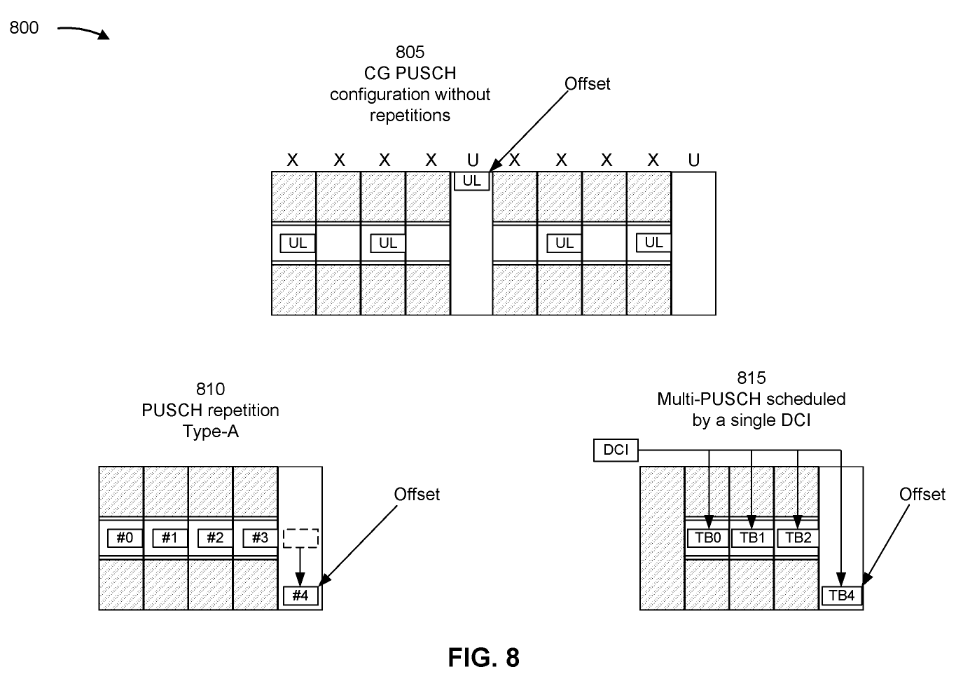

FIG. 8 is a diagram illustrating an example 800 configuration where uplink transmissions across SBFD symbols and non-SBFD symbols can be in SBFD symbols and non-SBFD symbols, in accordance with the present disclosure. In some examples, where Configuration 2 is enabled for UL PUSCH, a single resource configuration and/or indication for non-SBFD symbols and RB offsets configurations, indications, and/or determinations may enable determination of a frequency resource for SBFD symbols, according to different PUSCH configurations. For example, there may be a frequency offset between SBFD and non-SBFD symbols to enable a determination of frequency resources for SBFD symbols (e.g., in a non-SBFD slot) and/or for non-SBFD symbols (e.g., in an SBFD slot). Additionally, the number of PRBs may be the same for PUSCH transmissions in SBFD symbols and PUSCH transmissions in non-SBFD symbols.

As shown by reference number 805, for a CG PUSCH configuration without repetitions, if the transmission occasions are across SBFD symbols and non-SBFD symbols where each transmission occasion has either all SBFD or all non-SBFD symbols, a single resource configuration and/or indication for non-SBFD symbols and RB offsets configuration, indication, and/or determination may be used to determine frequency resources for SBFD symbols. For example, an UL SBFD transmission may be offset in a frequency resource for a non-SBFD slot relative to an SBFD slot.

As shown by reference number 810, for a PUSCH repetition type-A configuration across SBFD and non-SBFD symbols in different slots where each repetition has either all SBFD or all non-SBFD symbols, a single resource configuration and/or indication for non-SBFD symbols and RB offsets configuration, indication, and/or determination may be used to determine frequency resources for SBFD symbols. For example, an UL SBFD transmission (e.g., repetition #4 in FIG. 8) may be offset in a frequency resource for a non-SBFD slot relative to a SBFD slot.

As further shown by reference number 815, for a multi-PUSCH scheduled by a single DCI configuration across SBFD symbols and non-SBFD symbols, where each PUSCH within a slot has either all SBFD or all non-SBFD symbols and for TBoMS across SBFD symbols and non-SBFD symbols in different slots, where each transmission within a slot has either all SBFD or all non-SBFD symbols, a single resource configuration and/or indication for non-SBFD symbols and RB offsets configuration, indication, and/or determination may be used to determine frequency resources for SBFD symbols. For example, an UL SBFD transmission (e.g., TB4 in FIG. 8) may be offset in a frequency resource for a non-SBFD slot relative to a SBFD slot.

As indicated above, FIG. 8 is provided as an example. Other examples may differ from what is described with respect to FIG. 8.

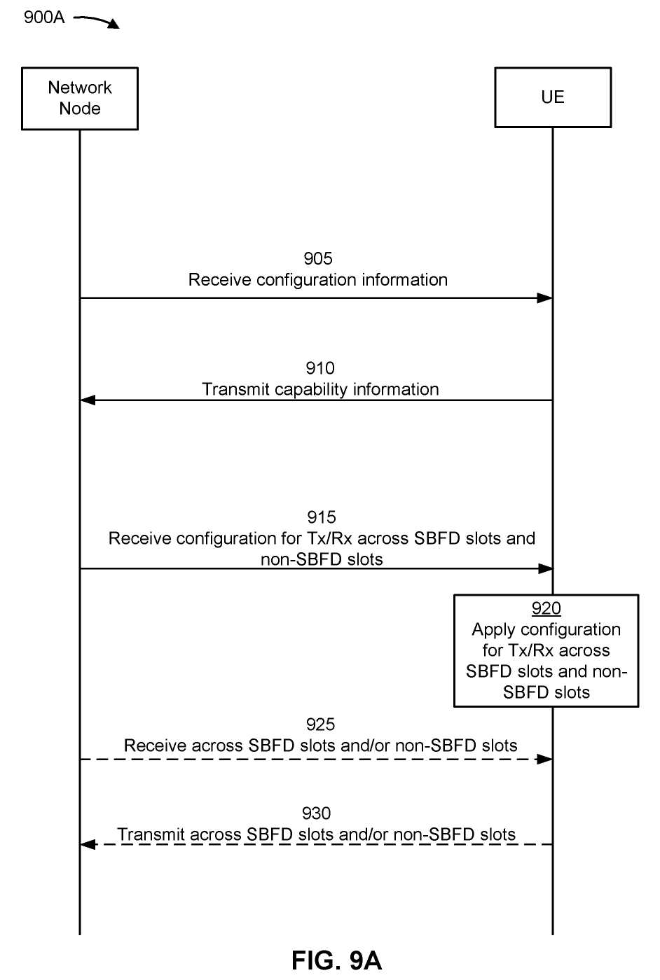

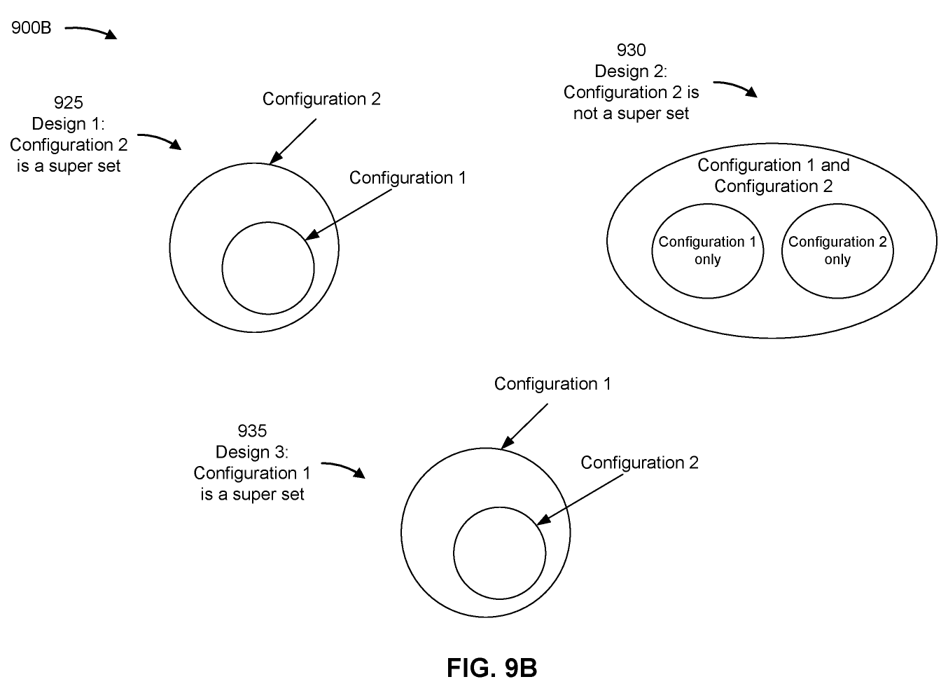

FIGS. 9A-9B are diagrams of examples 900A and 900B associated with SBFD-aware UE capability reporting and configurations, in accordance with the present disclosure. As shown in FIG. 9A, a network node (e.g., network node 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 9A.

As shown by reference number 905, the network node may transmit, and the UE may receive, configuration information. In some aspects, the UE may receive the configuration information via one or more of system information (e.g., a master information block (MIB) and/or a system information block (SIB), among other examples), RRC signaling, one or more MAC-CEs, and/or DL DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC-CEs and/or one or more DCI messages, among other examples.

In some aspects, the configuration information may indicate that the UE is to transmit capability information that indicates support for at least one of a first SBFD configuration or a second SBFD configuration.

The UE may configure itself based at least in part on the configuration information. In some aspects, the UE may be configured to perform one or more operations described herein based at least in part on the configuration information.

As shown by reference number 910, the UE may transmit, and the network node may receive, capability information. The capability information may indicate whether the UE supports a feature and/or one or more parameters related to the feature. For example, the capability information may indicate a capability and/or parameter for supporting at least one of a first SBFD configuration or a second SBFD configuration. As another example, the capability information may indicate a capability and/or parameter for the second SBFD configuration being a superset of the first SBFD configuration or for the first SBFD configuration being a superset of the second SBFD configuration. One or more operations described herein may be based on capability information of the capability information. For example, the UE may perform a communication in accordance with the capability information, or may receive configuration information that is in accordance with the capability information. In some aspects, the capability information may indicate UE support for at least one of a first SBFD configuration (e.g., supporting SBFD symbols only or non-SBFD symbols only) or a second SBFD configuration (e.g., supporting SBFD and non-SBFD symbols).

In some aspects, the configuration information described in connection with reference number 905 and/or the capability information may include information transmitted via multiple communications. Additionally, or alternatively, the network node may transmit the configuration information, or a communication including at least a portion of the configuration information, before and/or after the UE transmits the capabilities information. For example, the network node may transmit a first portion of the configuration information before the capability information, the UE may transmit at least a portion of the capability information, and the network node may transmit a second portion of the configuration information after receiving the capability information.

As shown by reference number 915, the network node may transmit, and the UE may receive, a configuration across SBFD slots and non-SBFD slots in accordance with the capability information. In some aspects, the configuration may be per SBFD slot or non-SBFD slot, or the configuration may be across SBFD slots and non-SBFD slots. For example, one or more components of the configuration may be for one or more SBFD slots and/or one or more non-SBFD slots. Additionally, or alternatively, the configuration may be applied across signal types and/or channel types, or one or more components of the configuration may be for one or more signal types and/or one or more channel types.

As shown by reference number 920, the UE may configure itself, based at least in part on receiving the configuration described in connection with reference number 915 to schedule and monitor transmissions and receptions according to the configuration. For example, the UE may apply the configuration received from the network node to transmissions and receptions across SBFD slots and non-SBFD slots.

As shown by reference number 925, the UE may receive messages across SBFD slots and/or non-SBFD slots according to the configuration. As shown by reference number 930, the UE may transmit messages across SBFD slots and/or non-SBFD slots according to the configuration.

In some aspects, for a UE reporting Configuration 1 and/or Configuration 2 capability and where the UE is semi-statically configured with Configuration 1 or Configuration 2 (e.g., on a per UE, per signal, and/or per channel basis), the UE may assume that the configuration does not apply to common signals and/or channels, including position reference signal (PRS), TRS, SSB, PDCCH, SIB, or the like. Additionally, or alternatively, the use of one or more of these signals (e.g., TRS) with Configuration 1 and/or Configuration 2 may be confined to DL transmissions in non-SBFD symbols. Additionally, or alternatively, the use of one or more of these signals (e.g., SSB and/or PDCCH) with Configuration 1 and/or Configuration 2 may be across DL transmissions and SBFD symbols (e.g., in a DL sub-band).

In some aspects, where the UE is configured with Configuration 2 (e.g., on a per UE, per signal, and/or per channel basis), the UE may not assume that the configuration applies to SRS and/or CSI-RS. In some aspects, for a UE that is semi-statically configured with Configuration 2 (e.g., on a per UE, per BWP, per signal, and/or per channel basis), the UE may expect that Configuration 2 applies to the following UL signals and channels: PUCCH, CG-PUSCH Type 1, CG-PUSCH Type 2, PUSCH repetition, PUCCH repetition, and/or multiple PUSCHs by single DCI. Similarly, for a UE that is semi-statically configured with Configuration 2 (e.g., on a per UE, per BWP, per signal, and/or per channel basis), the UE may expect that Configuration 2 applies to the following DL signals and channels: SPS, PDSCH repetition, and/or multiple PDSCHs by single DCI.

In some aspects, where one of the signals and/or channels (e.g., P/SP CSI-RS, SRS, or the like) that is applicable for Configuration 1 and the valid symbols should be configured (e.g., semi-statically) by a higher layer and the valid symbol is absent, the UE may be configured with one or more options. For example, in a first option, where the UE doesn’t expect the valid symbol to be absent, the UE may expect that Configuration 1 may apply to the following signals and channels and that a valid symbols type may always be configured, indicated, and/or determined for the following signals and channels: SRS, PUCCH, CG-PUSCH Type 1, CG-PUSCH Type 2, PUSCH repetition, PUCCH repetition, multiple PUSCHs by single DCI, SPS, CSI-RS, PDSCH repetition, and/or multiple PDSCHs by single DCI. Additionally, in a second option, the default symbol may be non-SBFD (e.g., SRS or CSI-RS) and the network node may not configure an SBFD-dedicated signal (e.g., SRS or CSI-RS). Furthermore, in a third option, Configuration 1 may not apply to the signals and/or channels and Configuration 2 may apply.

As shown in FIG. 9B, when the UE reports the capability of transmissions and receptions across SBFD and non-SBFD modes, the UE may report capabilities for Configuration 1 and/or Configuration 2 according to one of three designs, designated as Design #1, Design #2, and Design #3.

As shown by reference number 925, Design #1 may indicate that Configuration 2 is a superset of Configuration 1. Additionally, Configuration 1 may be the default configuration, where a UE supporting Configuration 1 as the default configuration may be unable to support configuration 2. However, in Configuration 2, a UE may be able to support both Configuration 1 and Configuration 2, where the UE may fallback to Configuration 1. In some aspects, for Design #1, the network node may be able to support Configuration 1 and Configuration 2 in order to accommodate different UEs.

As shown by reference number 930, Design #2 may indicate that Configuration 2 is not a superset of Configuration 1. In some aspects, a UE configured in accordance with Design #2 may indicate support for Configuration 1 only, Configuration 2 only, or Configuration 1 and Configuration 2. Additionally, for Design #2, the network node may be able to support Configuration 1 and/or Configuration 2.

As further shown by reference number 935, Design #3 may indicate that Configuration 1 is a superset of Configuration 2. Additionally, Configuration 2 may be the default configuration, where a UE supporting Configuration 2 as the default may be unable to support Configuration 1. However, in Configuration 1, the UE supporting Configuration 1 may be able to support Configuration 2. For example, the UE may be able to fallback from Configuration 1 to Configuration 2. In some aspects, for Design #3, the network node may be able to support Configuration 1 and Configuration 2 to accommodate different UEs.

In some aspects of Design #3 (e.g., Configuration 1 is a superset), the UE indicating support for Configuration 1 may also support Configuration 2. Additionally, or alternatively, when the UE is configured with Configuration 1 (e.g., per UE, per signal, and/or per channel), then some signals and/or channels may be semi-statically configured with a valid symbol type. If there is no configuration, then Design #3 may be applicable to both SBFD and non-SBFD symbols, where the UE may be allowed to fallback to Configuration 2. In some aspects of Design #1 and/or Design #3, where the UE does not expect a signal and/or channel to have a valid symbol type (e.g., SBFD or non-SBFD), then the UE may be unable to fallback to Configuration 2.

In some aspects, Configuration 1 and/or Configuration 2 may be applicable for dynamic signals across multiple slots. In some aspects, when the UE is configured with Configuration 2 according to Design #1, for dynamic scheduling of PUSCH and/or PDSCH repetitions, PUCCH repetition, and/or multiple PUSCH and/or PDSCH by single DCI, the UE may fall back to Configuration 1. For example, the network node may transmit, and the UE may receive, DCI including a bitfield that indicates the first SBFD configuration or the second SBFD configuration as the configuration across SBFD slots and non-SBFD slots.

Additionally, or alternatively, the network node may transmit, and the UE may receive, a scheduling configuration indicating the first SBFD configuration as the configuration across SBFD slots and non-SBFD slots for all occasions associated with a single type, where the single symbol type (e.g., all occasions and/or repetitions in consecutive SBFD symbols) is associated with one of an SBFD mode or a non-SBFD mode. For example, the UE may be provided with two sets of transmit precoding matrix indicators (TPMIs) and/or SRS resource indicators (SRIs), and the UE may select a TPMI and/or an SRI based on the symbol type (e.g., SBFD or non-SBFD). Based on the selection, the UE may apply an RB-offset to determine the RB-offset for all occasions associated with SBFD symbols, or the UE may ignore the RB-offset if all occasions are associated with non-SBFD symbols. However, in some aspects of Design #2 and Design #3, the UE does not expect fallback to Configuration 1.

As described herein, enabling Configuration 1 and Configuration 2 for managing SBFD communications poses challenges regarding default configurations, configuration reporting capabilities, whether the configurations may be supersets of one another, and whether the configurations may be limited to certain channels and/or signals. By enabling the UE to report its capabilities regarding Configuration 1 and Configuration 2, the UE and network node may adapt SBFD configurations to current network conditions and/or channel and/or signal conditions. For example, Configuration 1 may provide simpler separation between transmissions and/or receptions, resulting in limited interference; whereas Configuration 2 may provide higher throughput due to the use of SBFD and non-SBFD symbols, but may cause greater interference due to potentially less separation between transmissions and/or receptions. By enabling the UE to report its configuration capabilities, limit its use of Configuration 1 and Configuration 2 to certain signals and channels, and define the relationship between Configuration 1 and Configuration 2 (e.g., whether one is a superset of the other), the UE and network node may adapt transmission and reception activity to current network conditions, thereby increasing throughput and reducing latency.

As indicated above, FIGS. 9A-9B are provided as examples. Other examples may differ from what is described with respect to FIGS. 9A-9B.

FIG. 10 is a diagram illustrating an example process 1000 performed, for example, at a UE or an apparatus of a UE, in accordance with the present disclosure. Example process 1000 is an example where the apparatus or the UE (e.g., UE 120) performs operations associated with SBFD-aware UE capability reporting and configurations.

As shown in FIG. 10, in some aspects, process 1000 may include transmitting, to a network node, capability information that indicates support for at least one of a first SBFD configuration or a second SBFD configuration (block 1010). For example, the UE (e.g., using transmission component 1204 and/or communication manager 1206, depicted in FIG. 12) may transmit, to a network node, capability information that indicates support for at least one of a first SBFD configuration or a second SBFD configuration, as described above.

As further shown in FIG. 10, in some aspects, process 1000 may include receiving, from the network node, a configuration across SBFD slots and non-SBFD slots in accordance with the capability information (block 1020). For example, the UE (e.g., using reception component 1202 and/or communication manager 1206, depicted in FIG. 12) may receive, from the network node, a configuration across SBFD slots and non-SBFD slots in accordance with the capability information, as described above.

Process 1000 may include additional aspects, such as any single aspect or any combination of aspects described below and/or in connection with one or more other processes described elsewhere herein.

In a first aspect, the second SBFD configuration is a superset of the first SBFD configuration.

In a second aspect, alone or in combination with the first aspect, the first SBFD configuration is a default configuration across SBFD slots and non-SBFD slots.

In a third aspect, alone or in combination with one or more of the first and second aspects, fallback to the second SBFD configuration is unavailable for a signal or a channel associated with an invalid symbol type, based on the configuration across SBFD slots and non-SBFD slots being the first SBFD configuration.

In a fourth aspect, alone or in combination with one or more of the first through third aspects, process 1000 includes receiving, from the network node, DCI including a bitfield that indicates the first SBFD configuration or the second SBFD configuration as the configuration across SBFD slots and non-SBFD slots.

In a fifth aspect, alone or in combination with one or more of the first through fourth aspects, process 1000 includes receiving, from the network node, a scheduling configuration indicating the first SBFD configuration as the configuration across SBFD slots and non-SBFD slots for all occasions associated with a single symbol type, wherein the single symbol type is associated with one of an SBFD mode or a non-SBFD mode.

In a sixth aspect, alone or in combination with one or more of the first through fifth aspects, the first SBFD configuration is a superset of the second SBFD configuration.

In a seventh aspect, alone or in combination with one or more of the first through sixth aspects, the second SBFD configuration is a default configuration across SBFD slots and non-SBFD slots.

In an eighth aspect, alone or in combination with one or more of the first through seventh aspects, fallback to the second SBFD configuration is available for a semi-statically configured signal or channel associated with a valid symbol type.

In a ninth aspect, alone or in combination with one or more of the first through eighth aspects, fallback to the second SBFD configuration is unavailable for a signal or a channel associated with an invalid symbol type.

In a tenth aspect, alone or in combination with one or more of the first through ninth aspects, the capability information indicates support for the first SBFD configuration only, the second SBFD configuration only, or both the first SBFD configuration and the second SBFD configuration.

In an eleventh aspect, alone or in combination with one or more of the first through tenth aspects, the capability information that indicates support for the first SBFD configuration, and the configuration across SBFD slots and non-SBFD slots applies to a plurality of uplink signals and channels and a plurality of downlink signals and channels based on a determination of an absent semi-static configured symbol associated with the first SBFD configuration, and wherein at least one valid symbol type is associated with the plurality of uplink signals and channels and the plurality of downlink signals and channels.

In a twelfth aspect, alone or in combination with one or more of the first through eleventh aspects, the plurality of uplink signals and channels includes one or more of an SRS, a PUCCH, a CG-PUSCH Type 1, a CG-PUSCH Type 2, a PUSCH/PUCCH repetition, or multiple PUSCHs by single DCI.

In a thirteenth aspect, alone or in combination with one or more of the first through twelfth aspects, the plurality of downlink signals and channels includes one or more of an SPS signal, a CSI-RS, a PDSCH repetition, or multiple PDSCHs by single DCI.

In a fourteenth aspect, alone or in combination with one or more of the first through thirteenth aspects, the configuration indicates that a non-SBFD mode of the first SBFD configuration is a default configuration associated with a signal or a channel, based on a determination of an absent semi-static configured symbol associated with the respective signal or channel.

In a fifteenth aspect, alone or in combination with one or more of the first through fourteenth aspects, the configuration indicates the second SBFD configuration as an active configuration and the first SBFD configuration as an inactive configuration associated with a signal or a channel, based on a determination of an absent semi-static configured symbol associated with the respective signal or channel.

In a sixteenth aspect, alone or in combination with one or more of the first through fifteenth aspects, the configuration across SBFD slots and non-SBFD slots does not apply to an SRS or a CSI-RS based on the second SBFD configuration being the configuration across SBFD slots and non-SBFD slots.

In a seventeenth aspect, alone or in combination with one or more of the first through sixteenth aspects, the configuration across SBFD slots and non-SBFD slots applies to a PUCCH, a CG-PUSCH Type 1, a CG-PUSCH Type 2, a PUSCH/PUCCH repetition, multiple PUSCHs by single DCI, a semi-persistent scheduling signal, a PDSCH repetition, or multiple PDSCHs by single DCI based on the second SBFD configuration being the configuration across SBFD slots and non-SBFD slots.

In an eighteenth aspect, alone or in combination with one or more of the first through seventeenth aspects, the configuration across SBFD slots and non-SBFD slots does not apply to a PRS, a TRS, a PDCCH, or a SIB.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network node or an apparatus of a network node, in accordance with the present disclosure. Example process 1100 is an example where the apparatus or the network node (e.g., network node 110) performs operations associated with SBFD-aware UE capability reporting and configurations.

As shown in FIG. 11, in some aspects, process 1100 may include receiving, from a UE, capability information that indicates support for at least one of a first SBFD configuration or a second SBFD configuration (block 1110). For example, the network node (e.g., using reception component 1302 and/or communication manager 1306, depicted in FIG. 13) may receive, from a UE, capability information that indicates support for at least one of a first SBFD configuration or a second SBFD configuration, as described above.

As further shown in FIG. 11, in some aspects, process 1100 may include transmitting, to the UE, a configuration across SBFD slots and non-SBFD slots in accordance with the capability information (block 1120). For example, the network node (e.g., using transmission component 1304 and/or communication manager 1306, depicted in FIG. 13) may transmit, to the UE, a configuration across SBFD slots and non-SBFD slots in accordance with the capability information, as described above.

Process 1100 may include additional aspects, such as any single aspect or any combination of aspects described below and/or in connection with one or more other processes described elsewhere herein.

In a first aspect, the second SBFD configuration is a superset of the first SBFD configuration.

In a second aspect, alone or in combination with the first aspect, the first SBFD configuration is a default configuration across SBFD slots and non-SBFD slots.

In a third aspect, alone or in combination with one or more of the first and second aspects, fallback to the second SBFD configuration is unavailable for a signal or a channel associated with an invalid symbol type, based on the configuration across SBFD slots and non-SBFD slots being the first SBFD configuration.

In a fourth aspect, alone or in combination with one or more of the first through third aspects, process 1100 includes transmitting, to the UE, DCI including a bitfield that indicates the first SBFD configuration or the second SBFD configuration as the configuration across SBFD slots and non-SBFD slots.

In a fifth aspect, alone or in combination with one or more of the first through fourth aspects, process 1100 includes transmitting, to the UE, a scheduling configuration indicating the first SBFD configuration as the configuration across SBFD slots and non-SBFD slots for all occasions associated with a single symbol type, wherein the single symbol type is associated with one of an SBFD mode or a non-SBFD mode.

In a sixth aspect, alone or in combination with one or more of the first through fifth aspects, the first SBFD configuration is a superset of the second SBFD configuration.

In a seventh aspect, alone or in combination with one or more of the first through sixth aspects, the second SBFD configuration is a default configuration across SBFD slots and non-SBFD slots.

In an eighth aspect, alone or in combination with one or more of the first through seventh aspects, to the second SBFD configuration is available for a semi-statically configured signal or channel associated with a valid symbol type.

In a ninth aspect, alone or in combination with one or more of the first through eighth aspects, fallback to the second SBFD configuration is unavailable for a signal or a channel associated with an invalid symbol type.

In a tenth aspect, alone or in combination with one or more of the first through ninth aspects, the capability information indicates support for the first SBFD configuration only, the second SBFD configuration only, or both the first SBFD configuration and the second SBFD configuration.

In an eleventh aspect, alone or in combination with one or more of the first through tenth aspects, the capability information that indicates support for the first SBFD configuration, and the configuration across SBFD slots and non-SBFD slots applies to a plurality of uplink signals and channels and a plurality of downlink signals and channels based on a determination of an absent semi-static configured symbol associated with the first SBFD configuration, and wherein at least one valid symbol type is associated with the plurality of uplink signals and channels and the plurality of downlink signals and channels.

In a twelfth aspect, alone or in combination with one or more of the first through eleventh aspects, the plurality of uplink signals and channels includes one or more of an SRS, a PUCCH, a CG-PUSCH Type 1, a CG-PUSCH Type 2, a PUSCH/PUCCH repetition, or multiple PUSCHs by single DCI.

In a thirteenth aspect, alone or in combination with one or more of the first through twelfth aspects, the plurality of downlink signals and channels includes one or more of an SPS, a CSI-RS, a PDSCH repetition, or multiple PDSCHs by single DCI.

In a fourteenth aspect, alone or in combination with one or more of the first through thirteenth aspects, the configuration indicates that a non-SBFD mode of the first SBFD configuration is a default configuration associated with a signal or a channel, based on a determination of an absent semi-static configured symbol associated with the respective signal or channel.

In a fifteenth aspect, alone or in combination with one or more of the first through fourteenth aspects, the configuration across SBFD slots and non-SBFD slots does not apply to an SBFD-dedicated signal in the respective signal or channel.

In a sixteenth aspect, alone or in combination with one or more of the first through fifteenth aspects, the configuration indicates the second SBFD configuration as an active configuration and the first SBFD configuration as an inactive configuration associated with a signal or a channel, based on a determination of an absent semi-static configured symbol associated with the respective signal or channel.

In a seventeenth aspect, alone or in combination with one or more of the first through sixteenth aspects, the configuration across SBFD slots and non-SBFD slots does not apply to an SRS or a CSI-RS based on the second SBFD configuration being the configuration across SBFD slots and non-SBFD slots.

In an eighteenth aspect, alone or in combination with one or more of the first through seventeenth aspects, the configuration across SBFD slots and non-SBFD slots applies to a PUCCH, a CG-PUSCH Type 1, a CG-PUSCH Type 2, a PUSCH/PUCCH repetition, multiple PUSCHs by single DCI, a semi-persistent scheduling signal, a PDSCH repetition, or multiple PDSCHs by single DCI based on the second SBFD configuration being the configuration across SBFD slots and non-SBFD slots.

In a nineteenth aspect, alone or in combination with one or more of the first through eighteenth aspects, the configuration across SBFD slots and non-SBFD slots does not apply to a PRS, a TRS, a PDCCH, or a SIB.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 140 described in connection with FIG. 1) of the UE.

In some aspects, the apparatus 1200 may be configured to perform one or more operations described herein in connection with FIGS. 9A and 9B. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the UE described above in connection with FIG. 1, such as a radio, one or more RF chains, one or more transceivers, or one or more modems, each of which may in turn be coupled with one or more antennas of the UE.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1204 may be co-located with the reception component 1202.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit, to a network node, capability information that indicates support for at least one of a first SBFD configuration or a second SBFD configuration. The reception component 1202 may receive, from the network node, a configuration across SBFD slots and non-SBFD slots in accordance with the capability information.

The reception component 1202 may receive, from the network node, DCI including a bitfield that indicates the first SBFD configuration or the second SBFD configuration as the configuration across SBFD slots and non-SBFD slots.

The reception component 1202 may receive, from the network node, a scheduling configuration indicating the first SBFD configuration as the configuration across SBFD slots and non-SBFD slots for all occasions associated with a single symbol type, wherein the single symbol type is associated with one of an SBFD mode or a non-SBFD mode.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 155 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 145 described in connection with FIG. 1) of the network node.

In some aspects, the apparatus 1300 may be configured to perform one or more operations described herein in connection with FIGS. 9A and 9B. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network node described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the network node described above in connection with FIG. 1, such as a radio, one or more RF chains, one or more transceivers, or one or more modems, each of which may in turn be coupled with one or more antennas of the network node. In some aspects, the reception component 1302 and/or the transmission component 1304 may include or may be included in a network interface. The network interface may be configured to obtain and/or output signals for the apparatus 1300 via one or more communications links, such as a backhaul link, a midhaul link, and/or a fronthaul link.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1304 may be co-located with the reception component 1302.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive, from a UE, capability information that indicates support for at least one of a first SBFD configuration or a second SBFD configuration. The transmission component 1304 may transmit, to the UE, a configuration across SBFD slots and non-SBFD slots in accordance with the capability information.

The transmission component 1304 may transmit, to the UE, DCI including a bitfield that indicates the first SBFD configuration or the second SBFD configuration as the configuration across SBFD slots and non-SBFD slots.

The transmission component 1304 may transmit, to the UE, a scheduling configuration indicating the first SBFD configuration as the configuration across SBFD slots and non-SBFD slots for all occasions associated with a single symbol type, wherein the single symbol type is associated with one of an SBFD mode or a non-SBFD mode.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: transmitting, to a network node, capability information that indicates support for at least one of a first sub-band full-duplex (SBFD) configuration or a second SBFD configuration; and receiving, from the network node, a configuration across SBFD slots and non-SBFD slots in accordance with the capability information.

Aspect 2: The method of Aspect 1, wherein the second SBFD configuration is a superset of the first SBFD configuration.

Aspect 3: The method of Aspect 2, wherein the first SBFD configuration is a default configuration across SBFD slots and non-SBFD slots.

Aspect 4: The method of Aspect 2, wherein fallback to the second SBFD configuration is unavailable for a signal or a channel associated with an invalid symbol type, based on the configuration across SBFD slots and non-SBFD slots being the first SBFD configuration.

Aspect 5: The method of Aspect 2, further comprising: receiving, from the network node, downlink control information including a bitfield that indicates the first SBFD configuration or the second SBFD configuration as the configuration across SBFD slots and non-SBFD slots.

Aspect 6: The method of Aspect 2, further comprising: receiving, from the network node, a scheduling configuration indicating the first SBFD configuration as the configuration across SBFD slots and non-SBFD slots for all occasions associated with a single symbol type, wherein the single symbol type is associated with one of an SBFD mode or a non-SBFD mode.

Aspect 7: The method of any of Aspects 1-6, wherein the first SBFD configuration is a superset of the second SBFD configuration.

Aspect 8: The method of Aspect 7, wherein the second SBFD configuration is a default configuration across SBFD slots and non-SBFD slots.

Aspect 9: The method of Aspect 7, wherein fallback to the second SBFD configuration is available for a semi-statically configured signal or channel associated with a valid symbol type.

Aspect 10: The method of Aspect 7, wherein fallback to the second SBFD configuration is unavailable for a signal or a channel associated with an invalid symbol type.

Aspect 11: The method of any of Aspects 1-10, wherein the capability information indicates support for the first SBFD configuration only, the second SBFD configuration only, or both the first SBFD configuration and the second SBFD configuration.

Aspect 12: The method of any of Aspects 1-11, wherein the capability information that indicates support for the first SBFD configuration, and the configuration across SBFD slots and non-SBFD slots applies to a plurality of uplink signals and channels and a plurality of downlink signals and channels based on a determination of an absent semi-static configured symbol associated with the first SBFD configuration, and wherein at least one valid symbol type is associated with the plurality of uplink signals and channels and the plurality of downlink signals and channels.

Aspect 13: The method of Aspect 12, wherein the plurality of uplink signals and channels includes one or more of a sounding reference signal, a physical uplink control channel (PUCCH), a configured grant (CG)-physical uplink shared channel (PUSCH) Type 1, a CG-PUSCH Type 2, a PUSCH/PUCCH repetition, or multiple PUSCHs by single downlink control information.

Aspect 14: The method of Aspect 12, wherein the plurality of downlink signals and channels includes one or more of a semi-persistent scheduling signal, a channel state information reference signal, a physical downlink shared channel (PDSCH) repetition, or multiple PDSCHs by single downlink control information.

Aspect 15: The method of any of Aspects 1-14, wherein the configuration indicates that a non-SBFD mode of the first SBFD configuration is a default configuration associated with a signal or a channel, based on a determination of an absent semi-static configured symbol associated with the respective signal or channel.

Aspect 16: The method of any of Aspects 1-15, wherein the configuration indicates the second SBFD configuration as an active configuration and the first SBFD configuration as an inactive configuration associated with a signal or a channel, based on a determination of an absent semi-static configured symbol associated with the respective signal or channel.

Aspect 17: The method of any of Aspects 1-16, wherein the configuration across SBFD slots and non-SBFD slots does not apply to a sounding reference signal or a channel state information reference signal based on the second SBFD configuration being the configuration across SBFD slots and non-SBFD slots.

Aspect 18: The method of any of Aspects 1-17, wherein the configuration across SBFD slots and non-SBFD slots applies to a physical uplink control channel (PUCCH), a configured grant (CG)-physical uplink shared channel (PUSCH) Type 1, a CG-PUSCH Type 2, a PUSCH/PUCCH repetition, multiple PUSCHs by single downlink control information (DCI), a semi-persistent scheduling signal, a physical downlink shared channel (PDSCH) repetition, or multiple PDSCHs by single DCI based on the second SBFD configuration being the configuration across SBFD slots and non-SBFD slots.

Aspect 19: The method of any of Aspects 1-18, wherein the configuration across SBFD slots and non-SBFD slots does not apply to a positioning reference signal, a tracking reference signal, a physical downlink control channel, or a system information block.

Aspect 20: A method of wireless communication performed by a network node, comprising: receiving, from a user equipment (UE), capability information that indicates support for at least one of a first sub-band full-duplex (SBFD) configuration or a second SBFD configuration; and transmitting, to the UE, a configuration across SBFD slots and non-SBFD slots in accordance with the capability information.

Aspect 21: The method of Aspect 20, wherein the second SBFD configuration is a superset of the first SBFD configuration.

Aspect 22: The method of Aspect 21, wherein the first SBFD configuration is a default configuration across SBFD slots and non-SBFD slots.

Aspect 23: The method of Aspect 21, wherein fallback to the second SBFD configuration is unavailable for a signal or a channel associated with an invalid symbol type, based on the configuration across SBFD slots and non-SBFD slots being the first SBFD configuration.

Aspect 24: The method of Aspect 21, further comprising: transmitting, to the UE, downlink control information including a bitfield that indicates the first SBFD configuration or the second SBFD configuration as the configuration across SBFD slots and non-SBFD slots.

Aspect 25: The method of Aspect 21, further comprising: transmitting, to the UE, a scheduling configuration indicating the first SBFD configuration as the configuration across SBFD slots and non-SBFD slots for all occasions associated with a single symbol type, wherein the single symbol type is associated with one of an SBFD mode or a non-SBFD mode.

Aspect 26: The method of any of Aspects 20-25, wherein the first SBFD configuration is a superset of the second SBFD configuration.

Aspect 27: The method of Aspect 26, wherein the second SBFD configuration is a default configuration across SBFD slots and non-SBFD slots.

Aspect 28: The method of Aspect 26, wherein fallback to the second SBFD configuration is available for a semi-statically configured signal or channel associated with a valid symbol type.

Aspect 29: The method of Aspect 26, wherein fallback to the second SBFD configuration is unavailable for a signal or a channel associated with an invalid symbol type.

Aspect 30: The method of any of Aspects 20-29, wherein the capability information indicates support for the first SBFD configuration only, the second SBFD configuration only, or both the first SBFD configuration and the second SBFD configuration.

Aspect 31: The method of any of Aspects 20-30, wherein the capability information that indicates support for the first SBFD configuration, and the configuration across SBFD slots and non-SBFD slots applies to a plurality of uplink signals and channels and a plurality of downlink signals and channels based on a determination of an absent semi-static configured symbol associated with the first SBFD configuration, and wherein at least one valid symbol type is associated with the plurality of uplink signals and channels and the plurality of downlink signals and channels.

Aspect 32: The method of Aspect 31, wherein the plurality of uplink signals and channels includes one or more of a sounding reference signal, a physical uplink control channel (PUCCH), a configured grant (CG)-physical uplink shared channel (PUSCH) Type 1, a CG-PUSCH Type 2, a PUSCH/PUCCH repetition, or multiple PUSCHs by single downlink control information.

Aspect 33: The method of Aspect 31, wherein the plurality of downlink signals and channels includes one or more of a semi-persistent scheduling signal, a channel state information reference signal, a physical downlink shared channel (PDSCH) repetition, or multiple PDSCHs by single downlink control information.

Aspect 34: The method of any of Aspects 20-33, wherein the configuration indicates that a non-SBFD mode of the first SBFD configuration is a default configuration associated with a signal or a channel, based on a determination of an absent semi-static configured symbol associated with the respective signal or channel.

Aspect 35: The method of Aspect 34, wherein the configuration across SBFD slots and non-SBFD slots does not apply to an SBFD-dedicated signal in the respective signal or channel.

Aspect 36: The method of any of Aspects 20-35, wherein the configuration indicates the second SBFD configuration as an active configuration and the first SBFD configuration as an inactive configuration associated with a signal or a channel, based on a determination of an absent semi-static configured symbol associated with the respective signal or channel.

Aspect 37: The method of any of Aspects 20-36, wherein the configuration across SBFD slots and non-SBFD slots does not apply to a sounding reference signal or a channel state information reference signal based on the second SBFD configuration being the configuration across SBFD slots and non-SBFD slots.

Aspect 38: The method of any of Aspects 20-37, wherein the configuration across SBFD slots and non-SBFD slots applies to a physical uplink control channel (PUCCH), a configured grant (CG)-physical uplink shared channel (PUSCH) Type 1, a CG-PUSCH Type 2, a PUSCH/PUCCH repetition, multiple PUSCHs by single downlink control information (DCI), a semi-persistent scheduling signal, a physical downlink shared channel (PDSCH) repetition, or multiple PDSCHs by single DCI based on the second SBFD configuration being the configuration across SBFD slots and non-SBFD slots.

Aspect 39: The method of any of Aspects 20-38, wherein the configuration across SBFD slots and non-SBFD slots does not apply to a positioning reference signal, a tracking reference signal, a physical downlink control channel, or a system information block.

Aspect 40: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-39.

Aspect 41: An apparatus for wireless communication at a device, the apparatus comprising one or more memories and one or more processors coupled to the one or more memories, the one or more processors configured to cause the device to perform the method of one or more of Aspects 1-39.

Aspect 42: An apparatus for wireless communication, the apparatus comprising at least one means for performing the method of one or more of Aspects 1-39.

Aspect 43: A non-transitory computer-readable medium storing code for wireless communication, the code comprising instructions executable by one or more processors to perform the method of one or more of Aspects 1-39.

Aspect 44: A non-transitory computer-readable medium storing a set of instructions for wireless communication, the set of instructions comprising one or more instructions that, when executed by one or more processors of a device, cause the device to perform the method of one or more of Aspects 1-39.

Aspect 45: A device for wireless communication, the device comprising a processing system that includes one or more processors and one or more memories coupled with the one or more processors, the processing system configured to cause the device to perform the method of one or more of Aspects 1-39.

Aspect 46: An apparatus for wireless communication at a device, the apparatus comprising one or more memories and one or more processors coupled to the one or more memories, the one or more processors individually or collectively configured to cause the device to perform the method of one or more of Aspects 1-39.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
transmit, to a network node, capability information that indicates support for at least one of a first sub-band full-duplex (SBFD) configuration or a second SBFD configuration; and
receive, from the network node, a configuration across SBFD slots and non-SBFD slots in accordance with the capability information.

2. The UE of claim 1, wherein the second SBFD configuration is a superset of the first SBFD configuration.

3. The UE of claim 2, wherein the first SBFD configuration is a default configuration across SBFD slots and non-SBFD slots.

4. The UE of claim 2, wherein the one or more processors are further configured to cause the UE to:
receive, from the network node, downlink control information including a bitfield that indicates the first SBFD configuration or the second SBFD configuration as the configuration across SBFD slots and non-SBFD slots.

5. The UE of claim 2, wherein the one or more processors are further configured to cause the UE to:
receive, from the network node, a scheduling configuration indicating the first SBFD configuration as the configuration across SBFD slots and non-SBFD slots for all occasions associated with a single symbol type, wherein the single symbol type is associated with one of an SBFD mode or a non-SBFD mode.

6. The UE of claim 1, wherein the capability information that indicates support for the first SBFD configuration, and the configuration across SBFD slots and non-SBFD slots applies to a plurality of uplink signals and channels and a plurality of downlink signals and channels based on a determination of an absent semi-static configured symbol associated with the first SBFD configuration, and
wherein at least one valid symbol type is associated with the plurality of uplink signals and channels and the plurality of downlink signals and channels.

7. The UE of claim 6, wherein the plurality of uplink signals and channels includes one or more of a sounding reference signal, a physical uplink control channel (PUCCH), a configured grant (CG)-physical uplink shared channel (PUSCH) Type 1, a CG-PUSCH Type 2, a PUSCH/PUCCH repetition, or multiple PUSCHs by single downlink control information.

8. The UE of claim 6, wherein the plurality of downlink signals and channels includes one or more of a semi-persistent scheduling signal, a channel state information reference signal, a physical downlink shared channel (PDSCH) repetition, or multiple PDSCHs by single downlink control information.

9. The UE of claim 1, wherein the configuration indicates that a non-SBFD mode of the first SBFD configuration is a default configuration associated with a signal or a channel, based on a determination of an absent semi-static configured symbol associated with the respective signal or channel.

10. The UE of claim 1, wherein the configuration across SBFD slots and non-SBFD slots does not apply to a sounding reference signal or a channel state information reference signal based on the second SBFD configuration being the configuration across SBFD slots and non-SBFD slots.

11. The UE of claim 1, wherein the configuration across SBFD slots and non-SBFD slots applies to a physical uplink control channel (PUCCH), a configured grant (CG)-physical uplink shared channel (PUSCH) Type 1, a CG-PUSCH Type 2, a PUSCH/PUCCH repetition, multiple PUSCHs by single downlink control information (DCI), a semi-persistent scheduling signal, a physical downlink shared channel (PDSCH) repetition, or multiple PDSCHs by single DCI based on the second SBFD configuration being the configuration across SBFD slots and non-SBFD slots.

12. The UE of claim 1, wherein the configuration across SBFD slots and non-SBFD slots does not apply to a positioning reference signal, a tracking reference signal, a physical downlink control channel, or a system information block.

13. A network node for wireless communication, comprising:
one or more memories; and
one or more processors, coupled to the one or more memories, configured to cause the network node to:
receive, from a user equipment (UE), capability information that indicates support for at least one of a first sub-band full-duplex (SBFD) configuration or a second SBFD configuration; and
transmit, to the UE, a configuration across SBFD slots and non-SBFD slots in accordance with the capability information.

14. The network node of claim 13, wherein the second SBFD configuration is a superset of the first SBFD configuration.

15. The network node of claim 14, wherein the first SBFD configuration is a default configuration across SBFD slots and non-SBFD slots.

16. The network node of claim 14, wherein the one or more processors are further configured to cause the network node to:
transmit, to the UE, downlink control information including a bitfield that indicates the first SBFD configuration or the second SBFD configuration as the configuration across SBFD slots and non-SBFD slots.

17. The network node of claim 14, wherein the one or more processors are further configured to cause the network node to:
transmit, to the UE, a scheduling configuration indicating the first SBFD configuration as the configuration across SBFD slots and non-SBFD slots for all occasions associated with a single symbol type, wherein the single symbol type is associated with one of an SBFD mode or a non-SBFD mode.

18. The network node of claim 13, wherein the capability information that indicates support for the first SBFD configuration, and the configuration across SBFD slots and non-SBFD slots applies to a plurality of uplink signals and channels and a plurality of downlink signals and channels based on a determination of an absent semi-static configured symbol associated with the first SBFD configuration, and
wherein at least one valid symbol type is associated with the plurality of uplink signals and channels and the plurality of downlink signals and channels.

19. The network node of claim 13, wherein the configuration indicates that a non-SBFD mode of the first SBFD configuration is a default configuration associated with a signal or a channel, based on a determination of an absent semi-static configured symbol associated with the respective signal or channel.

20. A method of wireless communication performed by a user equipment (UE), comprising:
transmitting, to a network node, capability information that indicates support for at least one of a first sub-band full-duplex (SBFD) configuration or a second SBFD configuration; and
receiving, from the network node, a configuration across SBFD slots and non-SBFD slots in accordance with the capability information.
